(19) United States
(12) Patent Application Publication
(10) Pub. No.: US 2019/0272935 A1
(43) Pub. Date: Sep. 5, 2019

(54) Common mode choke for eliminating electrostatic interference

(71) Applicant: Chunlin Li, Dengzhou (CN)

(72) Inventor: Chunlin Li, Dengzhou (CN)

(21) Appl. No.: 16/398,266

(22) Filed: Apr. 30, 2019

(30) Foreign Application Priority Data
Mar. 28, 2019 (CN) 201910245605.X

(51) Int. Cl. H01F 17/04

(52) U.S. Cl. CPC H01F 17/045; H01F 2017/0093

(57) ABSTRACT

A common mode choke for eliminating an electrostatic interference is provided. Through dividing a conventional single winding into three separated windings, an internal winding capacitance is reduced and meanwhile an inductance of higher quality factor is generated; a common mode resistance is increased and a capacitance between turns is reduced; and a filtration efficiency of low frequency and high frequency is improved. Moreover, because a conventional single-hole structure is expanded to a two-hole structure and the conventional single winding is divided into three independent to windings, webs are formed in every winding hole, a first winding part, a second winding part and a third winding part. It is different from a single annular magnetic core that: multiple networks generated by a winding structure of the present invention will not be saturated under a same condition, so that an electrostatic interference of more than 6 kv can be eliminated.

### CROSS REFERENCE OF RELATED APPLICATION

The application claims priority under 35 U.S.C. 119(a-d) to CN 201910245605.X, filed Mar. 28, 2019.

### BACKGROUND OF THE PRESENT INVENTION

### Field of Invention

The present invention relates to a field of common mode choke, and more particularly to a common mode choke for eliminating an electrostatic interference.

### Description of Related Arts

In recent years, the common mode choke has been applied in eliminating the common mode noise from the balanced differential mode signal of the Ethernet application. The Ethernet in the automotive and industrial applications requires the high EMI/RFI (Electro-Magnetic Interference/Radio-Frequency Interference) filtration, so as to prevent the unconscious high energy generated by the power device from entering or leaving the shell. However, in the current automotive application, the conventional common mode choke is not enough to process the high-energy external noise generated by the high-power device and eliminate the electrostatic interference of more than 6 kv. Therefore, the present invention provides a common mode choke which is able to eliminate the electrostatic interference of more than 6 kv.

### SUMMARY OF THE PRESENT INVENTION

For the above purpose, the present invention provides a common mode choke which is able to eliminate an electrostatic interference of more than 6 kv.

Technical solutions of the present invention are described as follows.

A common mode choke for eliminating an electrostatic interference comprises a two-hole annular magnetic core and a winding wire; wherein:

a first winding hole and a second winding hole are provided on the two-hole annular magnetic core;

a first end of the winding wire passes through the first winding hole, and the winding wire is wound on the magnetic core between the first winding hole and an outer wall of the first winding hole, so as to form a first winding; then the winding wire is wound on the magnetic core between the first winding hole and the second winding hole, so as to form a second winding; next, the winding wire is wound on the magnetic core between the second winding hole and an outer wall of the second winding hole, so as to form a third winding; and finally, a second end of the winding wire passes through the second winding hole.

Preferably, the winding wire is anticlockwise wound on the magnetic core between the first winding hole and the outer wall of the first winding hole, so as to form the first winding; a leading-out wire of the first winding is anticlockwise wound on the magnetic core between the first winding hole and the second winding hole, so as to form the second winding; a leading-out wire of the second winding is anticlockwise wound on the magnetic core between the second winding hole and the outer wall of the second winding hole, so as to form the third winding; and a leading-out wire of the third winding is the second end of the winding wire.

Preferably, the winding wire is anticlockwise wound on the magnetic core between the first winding hole and the outer wall of the first winding hole, so as to form the first winding; a leading-out wire of the first winding is anticlockwise wound on the magnetic core between the first winding hole and the second winding hole, so as to form the second winding; a leading-out wire of the second winding is clockwise wound on the magnetic core between the second winding hole and the outer wall of the second winding hole, so as to form the third winding; and a leading-out wire of the third winding is the second end of the winding wire.

Preferably, the winding wire is anticlockwise wound on the magnetic core to between the first winding hole and the outer wall of the first winding hole, so as to form the first winding; a leading-out wire of the first winding is clockwise wound on the magnetic core between the first winding hole and the second winding hole, so as to form the second winding; a leading-out wire of the second winding is anticlockwise wound on the magnetic core between the second winding hole and the outer wall of the second winding hole, so as to form the third winding; and a leading-out wire of the third winding is the second end of the winding wire.

Preferably,the winding wire is anticlockwise wound on the magnetic core between the first winding hole and the outer wall of the first winding hole, so as to form the first winding; a leading-out wire of the first winding is clockwise wound on the magnetic core between the first winding hole and the second winding hole, so as to form the second winding; a leading-out wire of the second winding is clockwise wound on the magnetic core between the second winding hole and the outer wall of the second winding hole, so as to form the third winding; and a leading-out wire of the third winding is the second end of the winding wire.

Preferably, the winding wire comprises two parallel leading wires.

Further preferably, two ends of a first leading wire are respectively an “A” end and an “a” end; two ends of a second leading wire are respectively a “B” end and a “b” end; common mode currents on the leading wires flow into the common mode choke respectively from the “A” end and the “B” end, and flow out of the common mode choke respectively from the “a” end and the “b” end.

Preferably, a turn number of the first winding is m1, a turn number of the second winding is m2, and a turn number of the third winding is m3, wherein: m1 is an integer more than 2, m2 is an integer more than 2, and m3 is an integer more than 2.

Compared with the prior art, the common mode choke for eliminating the electrostatic interference provided by the present invention has beneficial effects as follows,

(1) Through dividing the conventional single winding into three separated windings, the internal winding capacitance is reduced and meanwhile the inductance of higher quality factor is generated; the common mode resistance is increased and the capacitance between turns is reduced; and the filtration efficiency of low frequency and high frequency is improved.

(2) Because the conventional single-hole structure is expanded to the two-hole structure and the conventional single winding is divided into three independent windings, webs are formed in every winding hole, a first winding part, a second winding part and a third winding part. It is different from the single annular magnetic core that: the multiple networks generated by the winding structure of the present invention will not be saturated under the same condition, so that the electrostatic interference of more than 6 kv can be eliminated.

### BRIEF DESCRIPTION OF THE DRAWINGS

In order to illustrate the technical solutions of the preferred embodiments of the present invention or the prior art more clearly, the accompanying drawings used in the description of the preferred embodiments or the prior art are simply described as follows. Apparently, the accompanying drawings described below are only some embodiments of the present invention, and persons of ordinary skill in the art can derive other drawings from the accompanying drawings without creative efforts.

FIG. 1 is a sketch view of a first conventional common mode choke in prior art.

FIG. 2 is a sketch view of a second conventional common mode choke in prior art.

FIG. 3 is a structural sketch view of a common mode choke for eliminating an electrostatic interference according to a first preferred embodiment of the present invention.

FIG. 4 is a structural sketch view of a magnetic core in the common mode choke for eliminating the electrostatic interference according to the first preferred embodiment of the present invention.

FIG. 5 is an equivalent circuit diagram of the common mode choke for eliminating the electrostatic interference according to a fifth preferred embodiment of the present invention.

### DETAILED DESCRIPTION OF THE PREFERRED EMBODIMENT

Technical solutions in the preferred embodiments of the present invention will be clearly and completely described as follows. Apparently, the described preferred embodiments are only sonic embodiments of the present invention, not all of the embodiments. Other embodiments made by one skilled in the art based on the embodiments of the present invention without creative efforts are all encompassed in the protection scope of the present invention.

### First Preferred Embodiment

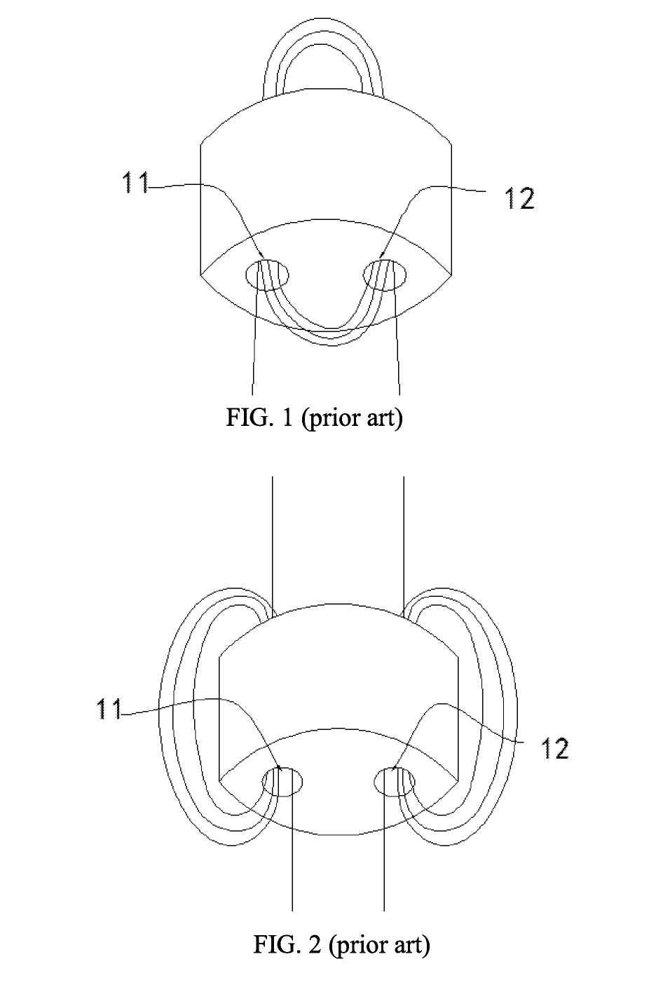

FIG. 1 shows a conventional annular common mode choke in prior art. For the common mode choke, only a leading wire is wound between two winding holes.

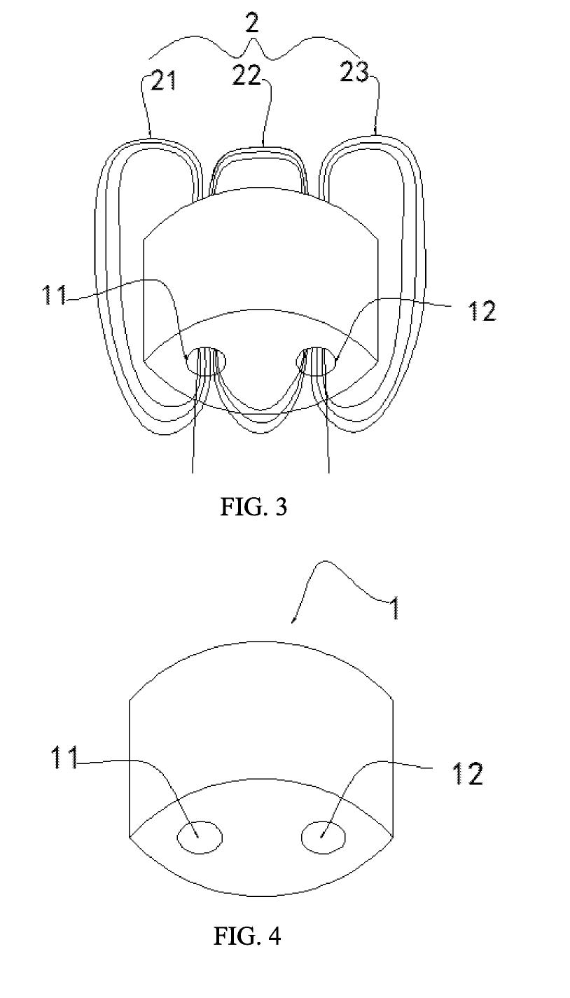

FIG. 2 shows a conventional common mode choke of a balanced-unbalanced transformer in prior art. For the common mode choke, leading wires are respectively wound along two winding holes and outer surfaces of the two winding holes.

The technical solutions shown in FIG. 1 and FIG. 2 are unable to eliminate an electrostatic interference of more than 6 kv. Therefore, the present invention provides a common mode choke able to eliminate the electrostatic interference of more than 6 kv.

As shown in FIG. 3, a common mode choke for eliminating an electrostatic interference comprises a magnetic core and a winding wire 2.

As shown in FIG. 4, according to the first preferred embodiment of the present invention, a first winding hole 11 and a second winding hole 12 are provided on the two-hole annular magnetic core 1.

In the first preferred embodiment, the winding wire 2 comprises two parallel leading wires. Two ends of a first leading wire are respectively an “A” end and an “a” end; two ends of a second leading wire are respectively a “B” end and a “b” end; common mode currents on the leading wires flow into the common mode choke respectively from the “A” end and the “B” end, and flow out of the common mode choke respectively from the “a” end and the “b” end; the “A” end and the “B” end form an input end of the common mode choke, and, the “a” end and the “b” end form an output end of the common mode choke. The two leading wires for transmitting the currents (such as the power wire and the ground wire of direct current supply, the live wire and the neutral wire of alternating current supply) are wound into the winding wire. At this time, the magnetic force lines generated in the magnetic core by the currents in the two leading wires have opposite directions and the intensities thereof are same, so that the forces cancel each other out and the total magnetic induction intensity in the magnetic core is 0; therefore, the magnetic core will not be saturated. For the common mode currents having the same direction on the two leading wires, there is no cancellation effect, and the inductance is relatively large, which has the suppression effect on the common mode interference current, but no suppression effect on the differential mode current.

In the first preferred embodiment, a winding way is that: the winding wire 2 is anticlockwise wound on the magnetic core between the first winding hole 11 and an outer wall of the first winding hole 11, so as to form a first winding 21; a leading-out wire of the first winding 21 is anticlockwise wound on the magnetic core between the first winding hole 11 and the second winding hole 12, so as to form a second winding 22; a leading-out wire of the second winding 22 is anticlockwise wound on the magnetic core to between the second winding hole 12 and an outer wall of the second winding hole 12, so as to form a third winding 23; and a leading-out wire of the third winding 23 is a second end of the winding wire 2. In short, in the first preferred embodiment, the winding way of the winding wire 2 is anticlockwise-anticlockwise-anticlockwise. Because the winding way in the first preferred embodiment starts from a lower end surface of the first winding hole of the two-hole annular magnetic core 1, if starting from an upper end surface of the first winding hole of the two-hole annular magnetic core 1, the winding way will be opposite to that in the first preferred embodiment, namely clockwise-clockwise-clockwise, which is substantially the same and not described in detail herein.

Furthermore, a turn number of the first winding 21 is m1, a turn number of the second winding 22 is m2, and a turn number of the third winding 23 is m3, wherein: m1 is an integer more than 2, m2 is an integer more than 2, and m3 is an integer more than 2.

According to the first preferred embodiment, through dividing the conventional single winding into three separated windings, the internal winding capacitance is reduced and meanwhile the inductance of higher quality factor is generated; the common mode resistance is increased and the capacitance between turns is reduced; and the filtration efficiency of low frequency and high frequency is improved. Moreover, because the conventional single-hole structure is expanded to the two-hole structure and the conventional single winding is divided into three independent windings, webs are formed in every winding hole, a first winding part, a second winding part and a third winding part. It is different from the single annular magnetic core that: the multiple networks generated by the winding structure of the present invention will not be saturated under the same condition.

### Second Preferred Embodiment

Based on the first preferred embodiment, the second preferred embodiment provides a second winding way. The winding way in the second preferred embodiment is that: the winding wire 2 is anticlockwise wound on the magnetic core between the first winding hole 11 and the outer wall of the first winding hole 11, so as to form the first winding 21; the leading-out wire of the first winding 21 is anticlockwise wound on the magnetic core between the first winding hole 11 and the second winding hole 12, so as to form the second winding 22; the leading-out wire of the second winding 22 is clockwise wound on the magnetic core between the second winding hole 12 and the outer wall of the second winding hole 12, so as to form the third winding 23; and the leading-out wire of the third winding 23 is the second end of the winding wire 2. In short, in the second preferred embodiment, the winding way of the winding wire 2 is anticlockwise-anticlockwise-clockwise. Because the winding way in the second preferred embodiment starts from the lower end surface of the first winding hole of the two-hole annular magnetic core 1, if starting from the upper end surface of the first winding hole of the two-hole annular magnetic core 1, the winding way will be opposite to that in the second preferred embodiment, namely clockwise-clockwise-anticlockwise, which is substantially the same and not described in detail herein.

### Third Preferred Embodiment

Based on the first preferred embodiment, the third preferred embodiment provides a third winding way. The winding way in the third preferred embodiment is that: the winding wire 2 is anticlockwise wound on the magnetic core between the first winding hole 11 and the outer wall of the first winding hole 11, so as to form the first winding 21; the leading-out wire of the first winding 21 is clockwise wound on the magnetic core between the first winding hole 11 and the second winding hole 12, so as to form the second winding 22; the leading-out wire of the second winding 22 is anticlockwise wound on the magnetic core between the second winding hole 12 and the outer wall of the second winding hole 12, so as to form the third winding 23; and the leading-out wire of the third winding 23 is the second end of the winding wire 2. In short, in the third preferred embodiment, the winding way of the winding wire 2 is anticlockwise-clockwise-anticlockwise. Because the winding way in the third preferred embodiment starts from the lower end surface of the first winding hole of the two-hole annular magnetic core 1, if starting from the upper end surface of the first winding hole of the two-hole annular magnetic core 1, the winding way will be opposite to that in the third preferred embodiment, namely clockwise-anticlockwise-clockwise, which is substantially the same and not described in detail herein.

### Fourth Preferred Embodiment

Based on the first preferred embodiment, the fourth preferred embodiment provides a fourth winding way. The winding way in the fourth preferred embodiment is that: the winding wire 2 is anticlockwise wound on the magnetic core between the first winding hole 11 and the outer wall of the first winding hole 11, so as to form the first winding 21; the leading-out wire of the first winding 21 is clockwise wound on the magnetic core between the first winding hole 11 and the second winding hole 12, so as to form the second winding 22; the leading-out wire of the second winding 22 is clockwise wound on the magnetic core between the second winding hole 12 and the outer wall of the second winding hole 12, so as to form the third winding 23; and the leading-out wire of the third winding 23 is the second end of the winding wire 2. In short, in the fourth preferred embodiment, the winding way of the winding wire 2 is anticlockwise-clockwise-clockwise. Because the winding way in the fourth preferred embodiment starts from the lower end surface of the first winding hole of the two-hole annular magnetic core 1, if starting from the upper end surface of the first winding hole of the two-hole annular magnetic core 1, the winding way will be opposite to that in the fourth preferred embodiment, namely clockwise-anticlockwise-anticlockwise, which is substantially the same and not described in detail herein.

### Fifth Preferred Embodiment

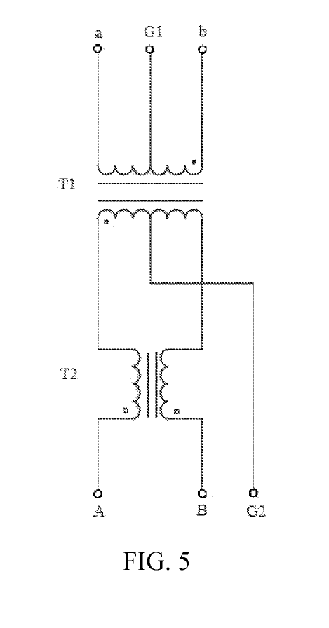

FIG. 5 shows an equivalent circuit diagram of the common mode choke, wherein: “G1” and “G2” ends connect to ground; the “A” end and the “B” end form an input end of the common mode choke, from which the two common mode currents flow into the common mode choke; the “a” end and the “b” end form an output end of the common mode choke, from which the two common mode currents flow out of the common mode choke; and a function of a second transformer T2 is to suppress the common mode currents. When the common mode currents flow into the common mode choke from the “A” and “B” ends, a first transformer T1 maintains an electric potential, and the second to transformer T2 suppresses the common mode interference signal. It can be known from experiments that: through increasing the turn numbers of the first winding 21, the second winding 22 and the third winding 23, the electrostatic interference of more than 6 kv can be eliminated by the common mode choke.

The above-described embodiments are only preferred embodiments of the present invention, not for limiting the present invention. Modifications, equivalent replacements and improvements made within the spirit and principle of the present invention are all encompassed in the protection scope of the present invention.

What is claimed is:

1. A common mode choke for eliminating an electrostatic interference, comprising a two-hole annular magnetic core (1) and a winding wire (2); wherein:
a first winding hole (11) and a second winding hole (12) are provided on the two-hole annular magnetic core (1);
a first end of the winding wire (2) passes through the first winding hole (11), and the winding wire (2) is wound on the magnetic core between the first winding hole (11) and an outer wall of the first winding hole (11), so as to form a first winding (21); then the winding wire (2) is wound on the magnetic core between the first winding hole (11) and the second winding hole (12), so as to form a second winding (22); next, the winding wire (2) is wound on the magnetic core between the second winding hole (12) and an outer wall of the second winding hole (12), so as to form a third winding (23); and finally, a second end of the winding wire (2) passes through the second winding hole (12).

2. The common mode choke for eliminating the electrostatic interference, as recited in claim 1, wherein: the winding wire (2) is anticlockwise wound on the magnetic core between the first winding hole (11) and the outer wall of the first winding hole (11), so as to form the first winding (21); a leading-out wire of the first winding (21) is anticlockwise wound on the magnetic core between the first winding hole (11) and the second winding hole (12), so as to form the second winding (22); a leading-out wire of the second winding is anticlockwise wound on the magnetic core between the second winding hole (12) and the outer wall of the second winding hole (12), so as to form the third winding (23); and a leading-out wire of the third winding (23) is the second end of the winding wire (2).

3. The common mode choke for eliminating the electrostatic interference, as recited in claim 1, wherein: the winding wire (2) is anticlockwise wound on the magnetic core between the first winding hole (11) and the outer wall of the first winding hole (11), so as to form the first winding (21); a leading-out wire of the first winding (21) is anticlockwise wound on the magnetic core between the first winding hole (11) and the second winding hole (12), so as to form the second winding (22); a leading-out wire of the second winding (22) is clockwise wound on the magnetic core between the second winding hole (12) and the outer wall of the second winding hole (12), so as to form the third winding (23); and a leading-out wire of the third winding (23) is the second end of the winding wire (2).

4. The common mode choke for eliminating the electrostatic interference, as to recited in claim 1, wherein: the winding wire (2) is anticlockwise wound on the magnetic core between the first winding hole (11) and the outer wall of the first winding hole (11), so as to form the first winding (21); a leading-out wire of the first winding (21) is clockwise wound on the magnetic core between the first winding hole (11) and the second winding hole (12), so as to form the second winding (22); a leading-out wire of the second winding (22) is anticlockwise wound on the magnetic core between the second winding hole (12) and the outer wall of the second winding hole (12), so as to form the third winding (23); and a leading-out wire of the third winding (23) is the second end of the winding wire (2).

5. The common mode choke for eliminating the electrostatic interference, as recited in claim 1, wherein: the winding wire (2) is anticlockwise wound on the magnetic core between the first winding hole (11) and the outer wall of the first winding hole (11), so as to form the first winding (21); a leading-out wire of the first winding (21) is clockwise wound on the magnetic core between the first winding hole (11) and the second winding hole (12), so as to form the second winding (22); a leading-out wire of the second winding (22) is clockwise wound on the magnetic core between the second winding hole (12) and the outer wall of the second winding hole (12), so as to form the third winding (23); and a leading-out wire of the third winding (23) is the second end of the winding wire (2).

6. The common mode choke for eliminating the electrostatic interference, as recited in claim 1, wherein the winding wire (2) comprises two parallel leading wires.

7. The common mode choke for eliminating the electrostatic interference, as recited in claim 6, wherein:
two ends of a first leading wire are respectively an “A” end and an “a” end;
two ends of a second leading wire are respectively a “B” end and a “b” end; and
common mode currents on the leading wires flow into the common mode choke respectively from the “A” end and the “B” end, and flow out of the common mode choke respectively from the “a” end and the “b” end.

8. The common mode choke for eliminating the electrostatic interference, as recited in claim 1, wherein: a turn number of the first winding (21) is m1; a turn number of the second winding (22) is m2; a turn number of the third winding (23) is m3; m1 is an integer more than 2; m2 is an integer more than 2; and m3 is an integer more than 2.
